(19) United States
(12) Patent Application Publication
(10) Pub. No.: US 2008/0293465 A1
(43) Pub. Date: Nov. 27, 2008

(54) Video interaction device for a whole-body sport game

(76) Inventor: Hong Chang, Taipei City (TW)

Correspondence Address: Joe McKinney Muncy, PO Box 1364, Fairfax, VA, 22038-1364, US

(21) Appl. No.: 11/802,863

(22) Filed: May 25, 2007

(51) Int. Cl. A63B 24/00; A63B 22/00; A63F 13/00

(52) U.S. Cl. 463/7; 482/1

(57) ABSTRACT

The present invention discloses a video interaction device, which integrates areas of a human upper body with a sport game software to achieve a video interaction via a display interface. The video interaction device of the present invention comprises: at least one foot-sensation member and at least one body motion-driving controller, which are respectively arranged in a foot exercise device and areas of a human upper body (such as a hand, the head, and the waist). Via the foot-sensation members and the body motion-driving controllers, a more precise and delicate whole-body interaction can be thus achieved between a user and a sport game software.

### FIELD OF THE INVENTION

The present invention relates to a video interaction device, particularly to a video interaction device for a whole-body sport game, whereby all areas of a human body can integrate with a sport game software.

### BACKGROUND OF THE INVENTION

Foot exercise devices have been used to assist in practicing physical exercise or sculpting the lower body for many years. However, the repeated motion of a foot exercise is apt to make a user feel flat and dull. Therefore, a user usually cannot practice the physical exercise persistently, and the foot exercise device will be finally abandoned or left unused in a stockroom. Hence, products integrating a foot exercise device and a video game were fabricated to increase the amusement effect of using a foot exercise device. Some of them utilize a foot exercise device as an input interface to control a game. Some utilize a combination of a joystick and a foot exercise device (such as an exercise bike or a treadmill) as an input interface. Nevertheless, the conventional products, which are limited by structural factors, are hard to provide more precise, more delicate and diversified interaction for a game. After a user has lost the fresh feeling, the improved conventional products cannot attract the user to use them either.

Besides, the conventional products only pay attention to increase users' interest of practicing a foot exercise but do not have any design to make a user able to practice a physical exercise of hands, the head or the neck simultaneously.

At present, has not existed yet a product, which can satisfy the diversified requirements of users and provide a whole-body video interaction between a user and a sport game software.

### SUMMARY OF THE INVENTION

The primary objective of the present invention is to provide a video interaction device for a whole-body sport game, which applies to various foot exercise devices and integrates a foot exercise with a hand exercise, a head exercise or even a waist exercise to interact with game video pictures.

The present invention proposes a video interaction device for a whole-body sport game, which is a video interaction device applying to a foot exercise device and integrating the foot exercise device with a hand exercise, a head exercise or even a waist exercise. The video interaction device of the present invention comprises: a host computer providing a game software, processing and transmitting signals; a display receiving signals from the host computer and presenting the pictures and information coming from the host computer; a foot-sensation member including at least one sensing element and at least one sensed element; and at least one body motion-driving controller in the form of a ring or a glove and sleeving one area of the upper body/worn by a user's hand. The sensing element is electrically coupled to the host computer and fixed to a specified position of a foot exercise device; the sensed element is arranged at the operating member of the foot exercise device and can be detected by the sensing element; the sensing and sensed elements are used to detect the timing and frequency of the motions of the operating member of the foot exercise device to control a game presented on the display via the host computer. The body motion-driving controller can detect the direction and speed of the motions of one area of a human body (such as a hand, a foot, the head, the waist, etc.) and transmits signals to the host computer via a transmission interface; a user can utilize the body motion-driving controller to control a sport game in the host computer.

The sensing and sensed elements may be mechanical switches, optoelectronic elements or magnetic elements.

The sensing/sensed element has at least one fixing element, whereby the sensing element is fixed to a specified position of a foot exercise device, and the sensed element is fixed to the operating member of the foot exercise device.

The transmission interface of the body motion-driving controller may be a USB (Universal Serial Bus) interface, a game port interface, an infrared interface, a Bluetooth interface, or a RFID (Radio Frequency Identification) interface.

Via the abovementioned technical schemes, the present invention has the following advantages: The body motion-driving controller enables the interaction between areas of the upper body and the images of a sport game software; the foot-sensation member enables the interaction between a foot and the images of a sport game software; thereby, a user can whole-body integrate with a sport game software; in cooperation with the display, a more precise and delicate whole-body interaction can thus be achieved between a user and a sport game software.

The conventional products are limited by structural factors. For example, only a foot exercise device is used as the input interface to control a sport game; alternatively, only the combination of a foot exercise device (such as an exercise bike or a treadmill) and a joystick is used as the input interface. No matter what kind of hardware a conventional product uses, it lacks a diversified, precise and delicate interaction. In contrast to the conventional products that only pay attention to increase users' interest of exercising their feet, the present invention integrates a foot exercise device with a hand, head or even waist exercise device to provide a high-entertainment and high-interaction whole-body video interaction device for a sport game.

### BRIEF DESCRIPTION OF THE DRAWINGS

FIG. 1 is a diagram schematically showing the application of the video interaction device for a whole-body sport game according to the present invention.

FIG. 2 is a diagram schematically showing the present invention applies to a foot ball exercise device.

FIG. 3 is a diagram schematically showing the present invention applies to a ball balance exercise device.

### DETAILED DESCRIPTION OF THE PREFERRED EMBODIMENTS

The technical contents of the present invention will be described in detail with the embodiments. However, it should be understood that the embodiments are only to exemplify the present invention but not to limit the scope of the present invention.

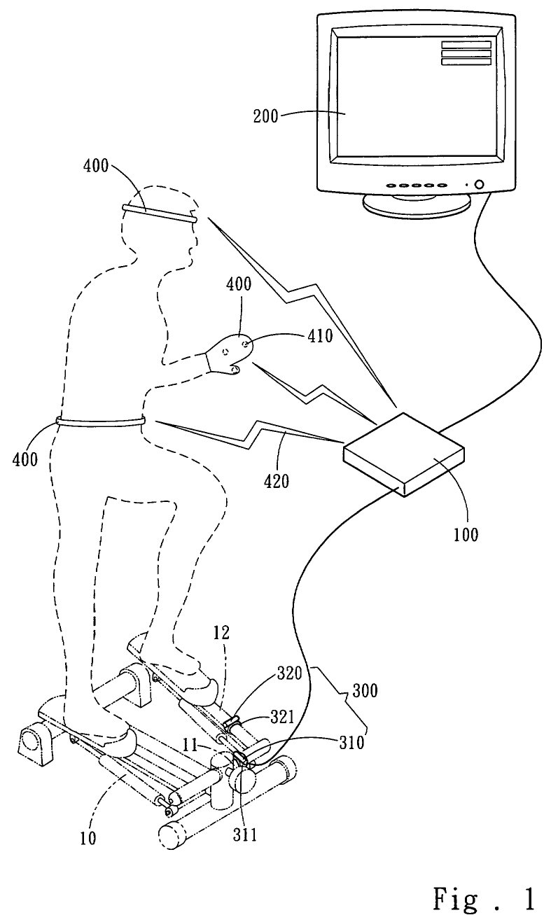

Refer to FIG. 1 a diagram schematically showing the application of the video interaction device for a whole-body sport game according to the present invention. The video interaction device for a whole-body sport game of the present invention is a video interaction device applying to a foot exercise device 10. The foot exercise device 10 may be a stepper, a treadmill, or an exercise bike. In FIG. 1, a stepper is used to exemplify the foot exercise device 10. The video interaction device of the present invention comprises: a host computer 100, a display 200, a foot-sensation member 300, and at least one body motion-driving controller 400.

The host computer 100 provides a game software, processes and transmits signals.

The display 200 receives signals from the host computer 100 and presents the pictures and information coming from the host computer 100.

The foot-sensation member 300 includes at least one sensing element 310 and at least one sensed element 320. The sensing element 310 is electrically coupled to the host computer 100. The sensing element 310 and the sensed element 320 may be mechanical switches, optoelectronic elements or magnetic elements.

The sensing element 310 has at least one fixing element 311, whereby the sensing element 310 is fixed to a fixing position 11 of the foot exercise device 10. The sensed element 320 also has at least one fixing element 321, whereby the sensed element 320 is fixed to the operating member 12 of the foot exercise device 10. The sensed element 320 should be installed in a place where the sensing element 310 can detect the sensed element 320. The sensing element 310 and the sensed element 320 are used to detect the timing and frequency of the motions of the operating member 12 of the foot exercise device 10 to control the actions of the protagonist of a game presented on the display 200 via the host computer 100.

The body motion-driving controller 400 may be in various forms. The body motion-driving controller 400 may be in the form of a ring sleeving one area of the upper body, such as a hand, the head or the waist. The body motion-driving controller 400 may be also in the form of a glove worn by a user's hand, and the glove may contain a plurality of sensors 410 to form a multi-extremities controller. The number of the body motion-driving controller 400 may vary with different games. The body motion-driving controller 400 can detect the direction and speed of the motions of a human body area (such as a hand, the head, the waist, etc.) and transmits signals to the host computer 100 via a transmission interface 420; a user can utilize the body motion-driving controller 400 to control a sport game the host computer 100 presents on the display 200. The transmission interface 420 may be a USB (Universal Serial Bus) interface, a game port interface, an infrared interface, a Bluetooth interface, or a RFID (Radio Frequency Identification) interface.

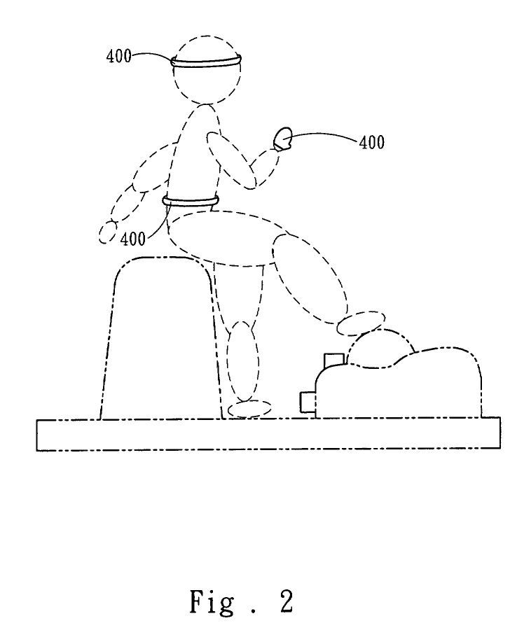

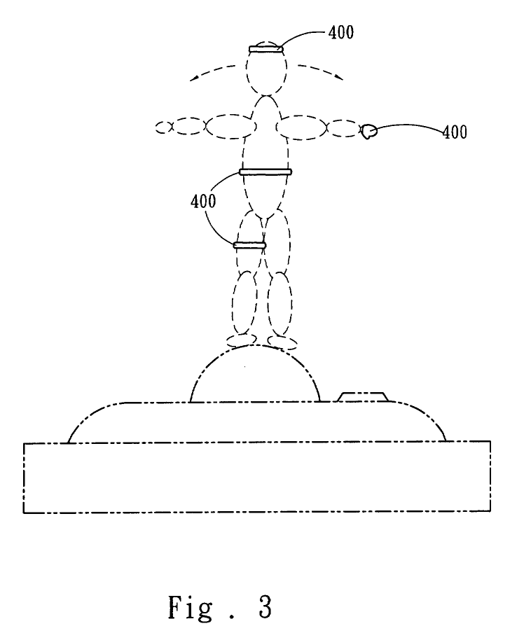

The present invention applies to various foot exercise devices and integrates a foot exercise device and an upper-body exercise with game animation to provide a video interaction device for a whole-body sport game. Refer to FIG. 2 and FIG. 3 diagrams schematically showing that the present invention respectively applies to a foot ball exercise device and a ball balance exercise device, wherein a plurality of body motion-driving controllers 400 arranged in upper-body areas (such as a hand, the head, the waist, etc.) cooperates with a foot exercise device to achieve more precise and delicate whole-body video interaction.

Those described above are only the preferred embodiments to exemplify the present invention but not to limit the scope of the present invention. Any equivalent modification or variation according to the spirit of the present invention is to be also included within the scope of the present invention.

What is claimed is:

1. A video interaction device for a whole-body sport game comprising:
a host computer providing a sport game software, processing and transmitting signals;
a display receiving signals from said host computer and presenting pictures and information coming from said host computer;
a foot-sensation member including at least one sensing element and at least one sensed element with said sensing element electrically coupled to said host computer; and
at least one body motion-driving controller detecting the direction and speed of the motions of a human upper body area and transmitting signals to said host computer via a transmission interface, wherein a user can utilize said body motion-driving controller and said foot-sensation member to control said sport game software in said host computer to achieve a video interaction with a whole-body sport game.

2. The video interaction device for the whole-body sport game according to claim 1, wherein said sensing element is fixed to a fixing position of a foot exercise device to detect said sensed element; said sensed element is fixed to an operating member of said foot exercise device; said sensed element should be installed in a place where said sensing element can detect said sensed element.

3. The video interaction device for the whole-body sport game according to claim 1, wherein said sensing element and said sensed element are mechanical switches, optoelectronic elements, or magnetic elements.

4. The video interaction device for the whole-body sport game according to claim 1, wherein either of said sensing element and said sensed element has at least one fixing element.

5. The video interaction device for the whole-body sport game according to claim 1, wherein said transmission interface is a USB (Universal Serial Bus) interface, a game port interface, an infrared interface, a Bluetooth interface, or a RFID (Radio Frequency Identification) interface.

6. The video interaction device for the whole-body sport game according to claim 1, wherein said body motion-driving controller is in the form of a ring.

7. The video interaction device for the whole-body sport game according to claim 1, wherein said body motion-driving controller is in the form of a glove.
